(19) United States
(12) Patent Application Publication
(10) Pub. No.: US 2009/0220636 A1
(43) Pub. Date: Sep. 3, 2009

(54) Actuating Device for Shut-Off Needles in Injection Molding Machines Having Needle Valve Nozzles

(76) Inventor: Herbert Gunther, Frankenberg (DE)

Correspondence Address: CLARK & BRODY, 1090 VERMONT AVENUE, NW, SUITE 250, WASHINGTON, DC, 20005, US

(21) Appl. No.: 12/087,508

(22) PCT Filed: Dec. 21, 2006
(86) PCT No.: PCT/EP2006/012400

§ 371 Date: Feb. 6, 2009

(30) Foreign Application Priority Data
Jan. 10, 2006 (DE) 20 2006 00 373.8
Sep. 12, 2006 (DE) 20 2006 014 168.5

(51) Int. Cl. B29C 45/03; F16K 31/44

(52) U.S. Cl. 425/564; 251/279

(57) ABSTRACT

The invention relates to an actuating device (10) for shut-off needles in injection molds having needle valve nozzles. The actuating device has at least one lifting element (20), to which at least two shut-off needles (16) may be fixed, and at least one actuating element (30) which is mounted so that it is longitudinally displaceable in a first direction (R1) and which is coupled to the lifting element (20) in such a way that a motion of the actuating element (30) along the first direction (R1) is converted to a motion of the lifting element (20) in a second direction (R2) transverse to the first direction (R1). In order to guide the sliding mechanism in a precise and consistently reliable manner, according to the invention the actuating element (30), which is slid in a guide unit (90) along the first direction (R1), is provided with an additional force-guided element (50).

The invention relates to an actuating device for shut-off needles in injection molds having needle valve nozzles, according to the preamble of Claim 1, and an injection mold according to Claim 18.

Needle valve nozzles are used in injection molds to feed a free-flowing composition, at a specifiable temperature under high pressure, to a removable mold insert. Needle valve nozzles usually have pneumatically, hydraulically, or electrically driven shut-off needles which periodically open and close the gate openings in the mold insert. For this purpose, each shut-off needle is mounted in the mold-side region of the injection molding machine in an axially displaceable manner, and in the nozzle-side region is preferably centrally guided through a flow channel for the composition to be processed. The flow channel ends in a nozzle end piece which forms a nozzle exit opening. In the closed position the lower end of the shut-off needle engages in a sealing seat provided in the nozzle end piece or in the mold insert.

To allow multiple needle valve nozzles to synchronously open and close in a mold, it is known from EP-A1-0 790 116, for example, to fix the shut-off needles on a common support plate which performs a lifting motion in the longitudinal direction of the shut-off needles. For this purpose the support plate is positioned on the end face side between two stationary stops, and is laterally positioned between two guide strips which are mounted inside a clamping plate in a longitudinally displaceable manner, and which on their lateral surfaces facing the support plate have obliquely oriented sliding blocks or sliding cams. The latter engage laterally in the support plate, which is provided with obliquely extending grooves. When the guide strips are pushed back and forth in the longitudinal direction by a drive, the support plate moves up and down, perpendicular thereto.

In an injection mold known from DE-A1-196 11 880 having multiple needle valve nozzles, each shut-off needle is fastened to a separate needle carrier element. At two opposite flat sides the latter are provided with obliquely oriented guide cams which engage in obliquely extending grooves in a fork-shaped sliding frame. Beneath the flat sides a cylindrical section is provided on each needle carrier element, which in the manner of a lifting piston is supported in a guide bush in an axially displaceable manner. When the sliding frame is moved back and forth, the individual needle carrier elements are moved up and down, perpendicular thereto.

DE-A1-199 07 116 discloses an actuating mechanism for die casting valve elements which is provided between two mold plates. The individual valve pins for a nozzle group are fixed to a common valve pin plate which is provided on the edges with guide bushes and which is able to slide up and down on guide pins extending parallel to the valve pins. Two actuating rods fastened to the valve pin plate bear multiple sliding blocks on the side. The latter engage in obliquely extending grooves in two cam elements which are mounted in a longitudinally displaceable manner between the upper mold plate and each respective retaining plate.

To prevent the lateral guide strips from jamming inside the actuating device, all components must be manufactured with exact tolerances and consistently positioned precisely within the mold. This is problematic in particular when the support plate or lifting plate has a relatively wide design. The farther apart the guide strips, the more likely the forward advancement of one or the other of the strips. This causes jamming of the components, which may result in malfunction or even damage. In addition, the support plate or valve pin plate cannot slide up and down precisely due to the nonuniform load on the oblique sliding blocks or sliding cams.

The object of the present invention is to provide a compact actuating device for injection molds having needle valve nozzles, which consistently moves all valve needles synchronously and acts on them with the same closing force. A particular aim is to achieve precise, consistently reliable guiding of the slide mechanism, in a design that is easy to manipulate and economical to implement.

The main features of the invention are stated in the characterizing part of Claim 1, and in Claim 18. Embodiments are the subject matter of Claims 2 through 17 and 19 through 27.

In an actuating device for shut-off needles in injection molds having needle valve nozzles, and having at least one lifting element to which at least two shut-off needles may be fixed, and at least one actuating element which is mounted so that it is longitudinally displaceable in a first direction and which is coupled to the lifting element in such a way that a motion of the actuating element along the first direction is converted to a motion of the lifting element in a second direction transverse to the first direction, according to the invention the actuating element, which is slid in a guide unit along the first direction, is provided with an additional force-guided element.

In this manner consistently uniform and stable guiding of the actuating element is ensured. Jamming of the actuating element which moves back and forth in the first direction is thus prevented. The actuating device consistently operates in a precise and reliable manner, in a design that is easy to manipulate and economical to implement.

This is particularly the case when the force-guided element is provided parallel to the guide unit and/or as a linear guide. The motive forces are thus always introduced parallel to the direction of motion of the actuating element, so that the actuating element is always guided in a correct position.

With regard to design, it is advantageous for the force-guided element to have at least one guide element which is slid in a bearing, the guide element being a round bolt, rectangular bolt, or the like, which may be provided in a bearing in the form of a recirculating ball bushing, a self-lubricating bushing, or the like.

In a further practical embodiment, the force-guided element is designed as a flat guide. This ensures a low profile with optimal guiding characteristics, so that the actuating device may be easily accommodated in an injection mold even under limited space conditions. The guide element is preferably a flat element, block piece, sliding block, or the like, whereas the bearing is formed from two guide rails which accommodate the guide element in a sliding manner. In one alternative embodiment, the bearing is a ball bearing, needle bearing, or roller bearing, which likewise ensures low-friction and precise guiding of the flat element.

In a further design of the invention, the guide element and/or the bearing have a self-lubricating design. As a result, the actuating device is practically maintenance-free, which ensures consistently reliable operation.

In one refinement of the invention, the guide element is connected or fastened to the actuating element. In one advantageous embodiment, the actuating element has two sliding control rails, and at least two sliding elements are provided in grooves extending obliquely with respect to the first direction and the second direction, between the lifting element and the control rails, the sliding elements converting a motion of the control rails along the first direction to a motion of the lifting element in the second direction. It is practical for the actuating element or the control rails to be connected or connectable to a drive via a push element, so that only one central drive unit is necessary.

The guide element is advantageously attached to at least one control rail. Additionally or alternatively, however, the guide element may be fixed to the push element which connects the control rails to the drive. The entire actuating element is thus consistently guided in a precise manner by the flat guide; the guide element may also be designed as one piece with the push element.

A particularly precise and uniform motion is achieved when the guide element is provided or situated centrally with respect to the push element. The motive forces are thus always centrally introduced into the push element, which is particularly advantageous when the control rails have a symmetrical design with respect to the push element. The control rails are uniformly moved in a precise manner and are held in the correct position. Advancement of one rail or the other is no longer possible. Use of such a guide ensures consistently precise operation of the entire machine, and allows the lifting plate to be uniformly moved up and down from any position. Jamming or sticking of the slid components is effectively prevented.

In a further embodiment, at least two force-guided elements and/or two guide elements may be provided adjacent and parallel to one another. These elements as well are preferably symmetrically situated in the actuating device, thereby further increasing the overall precision and stability of guiding.

According to a further advantageous embodiment of the invention, the control rails may be connected to at least two additional control rails, between which at least one additional lifting element is provided. At least two additional shut-off needles may be fixed to this additional lifting element, which is connected to the additional control rails in such a way that a motion of the additional control rails along the first direction is converted to a motion of the lifting element in the second direction, transverse to the first direction.

Fixing the valve needles to the common lifting elements and connecting the control rails ensures that all valve needles are always moved synchronously and acted on with the same closing force.

The control rails are detachably connected to one another, thus allowing expansions to be made at any time and then returned to the original configuration. It is advantageous to provide the connection between the control rails as a plug-in or hook connection. A fixed connection between the control rails along the first direction is important in order to consistently actuate the lifting elements in a reliable manner.

To allow the actuating device and the valve needles to be individually adapted to the mold, the valve needles are designed to be adjustable relative to the lifting element, along the second direction. To also consistently ensure a synchronous adjustment motion with simultaneous compensation of motion, according to a further aspect of the invention the valve needles may be fixed to the lifting elements in an axially locked and radially floating manner.

In one special embodiment of the invention, the actuating device is provided in an injection mold, in particular in or on a clamping plate. For this purpose the clamping plate is provided with an indentation, for example, for accommodating the actuating device, thereby simplifying installation.

The bearing for the force-guided element, the same as for the guide unit, is preferably provided on or in the clamping plate, the guide unit being formed by the clamping plate itself or by at least two guide rails which are fastened on or in the clamping plate, and the control rails being slid between the guide rails. With regard to design it is also advantageous to provide the bearing for the force-guided element in the base of the clamping plate. The force-guided element thus occupies only a small space, which is also favorable for the profile height of the actuating device.

The guide unit for the actuating device has at least two guide rails which are fastened to or in the clamping plate, the control rails being slid between the guide rails.

To reduce the sliding friction of the actuating element within the guide unit, according to the invention the actuating element and/or the guide unit and/or the clamping plate have or bear sliding elements. These are preferably flat sliding strips or sliding plates which thus occupy little space, which is favorable for the profile height. Such elements may be easily and economically manufactured, quickly and conveniently installed, and replaced as needed. Particularly good friction characteristics are achieved when the sliding elements are made, at least partially, of a self-lubricating material or are at least partially coated with same. Additionally or alternatively, the sliding elements may also be designed as ball bearings, needle bearings, or roller bearings, or may be parts of such bearings.

Further significant advantages result when the actuating device is in flush abutment with the clamping plate. The profile height of the injection mold is not changed as a result.

Further features, particulars, and advantages of the invention result from the text of the claims and the following description of exemplary embodiments with reference to the drawings, which show the following:

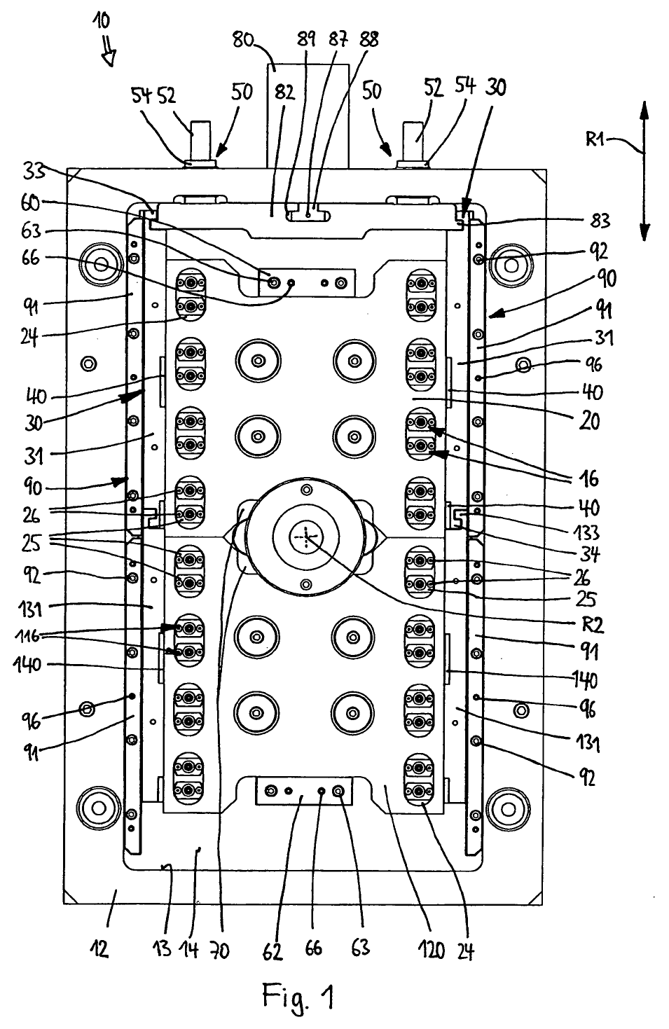

FIG. 1 shows a top view of one embodiment of an actuating device for injection molds;

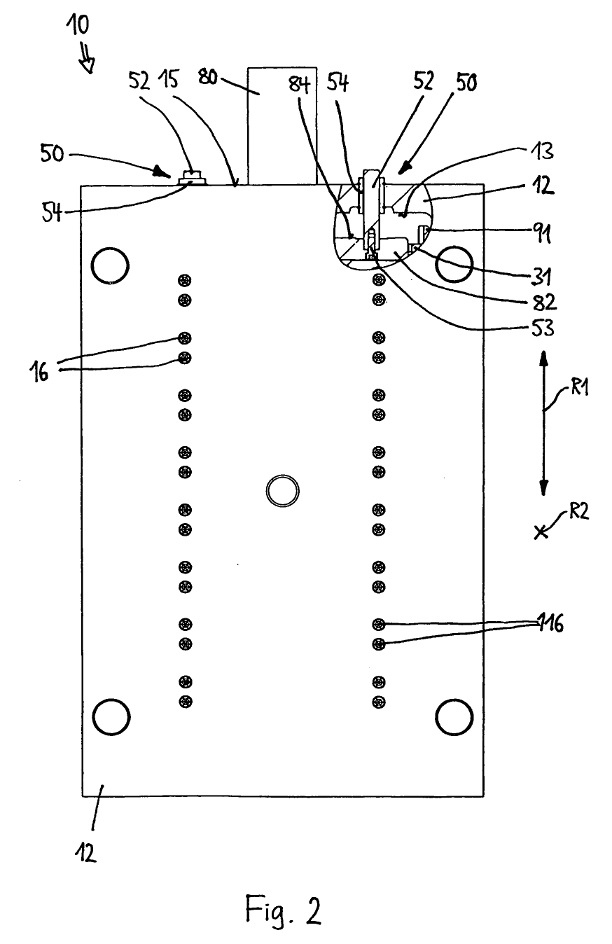

FIG. 2 shows a top view of a further embodiment of an actuating device for injection molds;

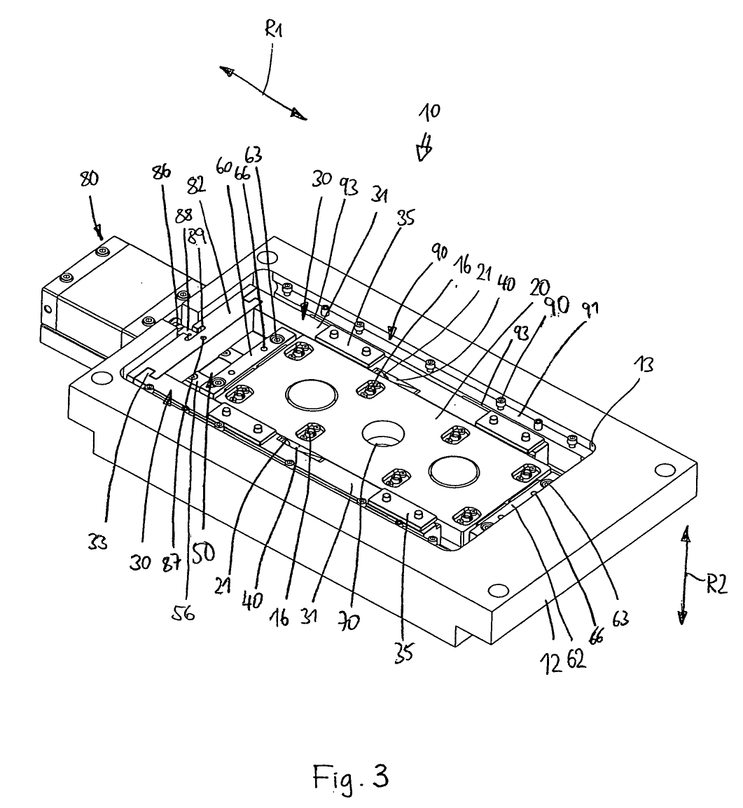

FIG. 3 shows an oblique view of a further embodiment of an actuating device for injection molds;

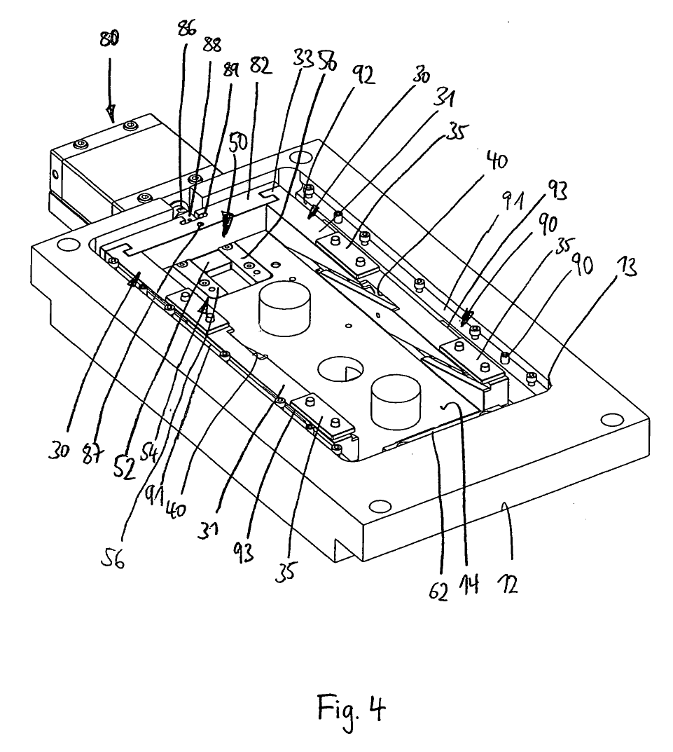

FIG. 4 shows the actuating device of FIG. 3 without a lifting plate; and

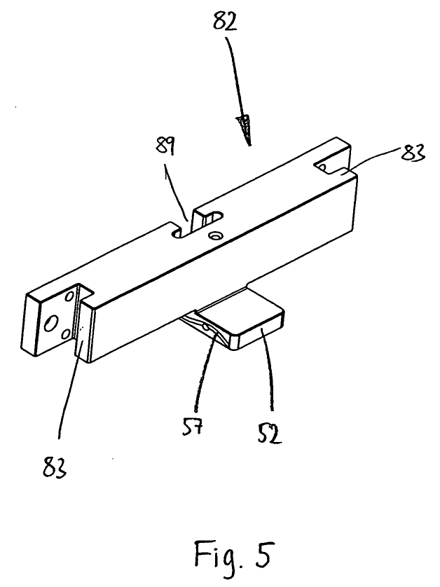

FIG. 5 shows a detailed illustration of a push element.

The actuating device denoted in general by reference numeral 10 in FIG. 1 is provided for the actuation of multiple shut-off needles 16 in an injection molding machine (not further illustrated). The injection molding machine is used for producing molded parts from a free-flowing composition, for example a plastic melt. To this end, multiple needle valve nozzles (not illustrated) are provided beneath a distribution plate (likewise not illustrated). The needle valve nozzles conduct the plastic melt to be processed to a removable mold insert (likewise not illustrated), the gate openings of the mold insert being periodically opened and closed by the shut-off needles 16. Located above the distribution plate is a clamping plate 12, which is provided for accommodating the actuating device 10 in an essentially rectangular depression or recess 13.

To allow the shut-off needles 16 for the needle valve nozzles to be simultaneously actuated, a lifting element 20 is provided on which at least two shut-off needles 16 are fastened. The lifting element 20 is designed as a rectangular plate, for example, which is parallel to the clamping plate 12 and which on its long side is connected to an actuating element 30 which is mounted so that it is longitudinally displaceable in a first direction R1, whereby a motion of the actuating element 30 along the first direction R1 is converted to a motion of the lifting element 20 in a second direction R2 transverse to the first direction R1. For this purpose the lifting plate 20 bears two sliding elements 21, one on each side, which are slid in parallel in the actuating element 30. To this end, the lateral surfaces of the actuating element facing the lifting plate 20 are provided with respective grooves 40 which extend at an angle with respect to the clamping plate 12 and accommodate the sliding elements 21 with a slight amount of play.

The actuating element 30 is formed by two displaceably mounted control rails 31 situated on each side of the lifting plate 20. The lifting plate rests with its end face between stationary stops 60, 62, which are fixed in the depression 13 in the clamping plate 12 by means of screws 63. Alignment pins 66 provide precise alignment of the stops 60, 62, which preferably have a rectangular cross section, the pins 66 being securely fixed in the clamping plate 12 and accommodated with an exact fit in boreholes (not further described) in the stops 60, 62.

The control rails 31 are slid inside the depression 13 in a guide unit 90, and are connected to a drive 80 via a common push element 82 and an adapter piece 86 (not visible in FIG. 1). The adapter piece is preferably externally fastened to the clamping plate 12, and is guided through the clamping plate 12 through an opening or recess (not illustrated) on the end face side. The drive 80 may be an electric, pneumatic, or hydraulic actuating drive or motor which is preferably actuated by a control electronics system (likewise not shown). The connection between the push element 82 and the adapter piece 86 forms a sliding block 88 having a T-shaped cross section which, likewise without a tool, is inserted into the push element 82 in a form-fit manner. For this purpose the push element is provided with a cutout 89. The sliding block 88 is secured to the adapter piece by a spring dowel pin 87.

Each control rail 31 has a hook-shaped end 33 on the drive side which may be laterally engaged with the push element 82. For this purpose the push element has two step-shaped ends 83 which are accommodated in a form-fit manner by the hooks 33 for the control rails 31 directed inwardly and perpendicular to the first direction R1. This results in a connection which is always secure in the first direction R1 and which may be released perpendicularly thereto. Components 31, 82 of the actuating element 30 may thus be quickly installed and removed at any time when a longer and/or wider lifting plate 20, for example, is used. During installation the elements 31, 82 may be easily placed one inside the other without a tool, forming a U-shaped assembly in the installed state which is securely joined together. The entire actuating device 10 may be manipulated very easily, and the installation costs are minimal.

The guide unit 90 is formed either by the clamping plate 12 or by at least two separate guide rails 91. The guide rails rest laterally in the depression 13 in the adapter plate 12. The guide rails are fastened by screws to the base 14 of the depression 13, and at each lateral surface facing the control rails 31 are provided with a continuous guide groove (not visible) extending parallel to the adapter plate 12. Each guide groove accommodates a sliding strip (likewise not shown) with a small amount of play, the sliding strip being provided on a lateral surface of the control rail 31 facing one of the guide rails 91.

Alignment pins 96 (not further described) provide precise alignment of the guide rails 91 inside the depression 13. The alignment pins are fixedly inserted in the base 14 of the clamping plate 12, and are accommodated with an exact fit by boreholes (not further described) in the guide rails 91.

In the alternative embodiment illustrated in FIGS. 3 and 4, the guide rails 91 bear two sliding plates 93 at their lateral surfaces 92 facing the control rails 31, the sliding plates preferably being coated with a self-lubricating material or made of same.

It is shown that the actuating element 30, comprising the control rails 31 and the push element 82, which is slid in direction R1 forms a U-shaped insertion frame which laterally encloses the lifting plate 20 with a slight amount of play and is slid inside the guide unit 90. To further reduce the sliding friction within the actuating device 10, the control rails 31 are provided at the top and bottom with sliding plates 35 which are either made of a self-lubricating material or are at least partially coated with same. The sliding plates 35 for the control rails 31 together with the sliding plates 93 for the guide rail form sliding elements, thus allowing the actuating element 30 to be moved back and forth with little expenditure of force. Additionally or alternatively, the sliding elements 35, 93 may also be designed as sliding strips or as ball bearings, needle bearings, or roller bearings. However, the sliding elements may also be components of ball bearings, needle bearings, or roller bearings.

As further shown in FIG. 1, additional control rails 131 may be connected to the control rails 31. Situated between same, parallel to the clamping plate 12, is an additional lifting element 120, which in the form of a rectangular plate having the same width adjoins the first lifting plate 20, and to which additional shut-off needles 116 are fastened. Both plates 20, 120 together rest in the longitudinal direction between the stationary stops 60, 62.

For connecting the additional control rails 131 to the control rails 31, the ends 34 of the control rails 31 facing away from the push element 82 and the ends 133 of the additional control rails 131 facing the drive 80 likewise have a hook-shaped design, the hook ends 34 of the control rails 31 and the hook ends 133 of the additional control rails 131 having congruent shapes and respectively pointing in the opposite direction, perpendicular to the first direction R1. The hooks 34, 133 engage with one another in a form-fit manner, resulting in a connection which is always fixed in the first direction R1 and which may be released in the direction perpendicular thereto.

In this manner the control rails 31, 131 may be quickly and easily joined together at the ends 34, 133 by simple latching or insertion. The actuating device 10 may thus be expanded by additional lifting plates 120 at any time without great effort by fastening or connecting additional control rails 131 to the control rails 31 already present. The additional control rails are connected to the drive 80 via the control rails 31 and the push element 82, so that an additional drive unit is not necessary. This is also very advantageous for the mold costs.

The additional lifting plate 121, the same as the lifting plate 21, bears sliding elements, one on each side, which are slid in parallel in the control rails 131. The lateral surfaces of the control rails facing the lifting plate 120 are provided with respective grooves 140 which extend at an angle with respect to the clamping plate 12 and accommodate the sliding elements with a slight amount of play. The additional control rails 131 are likewise slid longitudinally between two stationary guide rails 91 for the guide unit 90.

When the drive 80 periodically moves the frame 30 back and forth in the first direction R1, lifting plates 20, 120 which are forcibly guided between the stops 60, 62 by the sliding elements in the oblique grooves 40, 140 in the control rails 31, 131 are moved up and down in the second direction R2, which is preferably perpendicular to direction R1. The lifting plates 20, 120 which planarly adjoin one another at their end faces (not further described), together with the shut-off needles 16, 116 fixed thereto, thus perform a synchronous lifting motion, all shut-off needles 16, 116 being consistently actuated at the same time and with the same actuating force.

To prevent the U-shaped actuating element 30 from jamming between the lifting plates 20, 120 and the guide unit 90 during operation, parallel to the guide rails 91 a force-guided element 50 is provided which additionally guides the actuating element 30 along direction R1. The force-guided element 50 is preferably designed as a linear guide. The force-guided element has a respective oblong guide element 52, symmetrically provided on each side of the drive 80, which is forcibly guided in a bearing 54.

The guide elements 52 are round bolts, for example, which by means of screws 53 are fastened to the push element 82. To ensure a precise perpendicular alignment of the bolts 52 above the end face 84 of the push element 82 facing the drive 80, blind holes (not further described) are provided in the push element which accommodate the bolts 52 with an exact fit. The bolts are always parallel to direction R1, and project through the end face 15 of the clamping plate 12 facing the drive 80.

Each bearing 54 is a recirculating ball bushing, for example, which is inserted into the end face of the clamping plate 12 and accommodates the associated guide bolts 52 with the least possible amount of play. The guide bolts 52 are always precisely guided inside the recirculating ball bushings 54, which likewise are aligned parallel to direction R1, so that the sliding frame 30 by necessity must be precisely guided in direction R1. Thus, jamming of the pusher 30 with respect to the lifting plates 20, 120 and/or the guide rails 91 is essentially prevented. The actuating device 10 ensures consistently precise and uniform guiding of the frame 30 in the guide unit 90.

In the embodiment in FIGS. 3 through 5, the force-guided element 50 designed as a linear guide has a guide element 52, centrally located with respect to the drive 80, which is slid in a bearing 54. The bearing is formed by two guide rails 56 which are inset in the base 14 of the clamping plate 12 and securely screwed at that location.

As shown in particular in FIG. 5, the guide element 52 is designed as an oblong flat element, provided in one piece with the push element 82. The guide element is situated exactly in the middle of the push element 82, and is therefore centrally located between the control rails 31. Lateral grooves 57 on both sides of the flat element 52 accommodate lubricant which minimizes the sliding friction inside the bearing 54. The overall assembly is therefore essentially maintenance-free.

The guide element 52 is guided precisely between the guide rails 56 for the bearing 54; i.e., the push element 82 cannot become jammed or twist inside the device 10. This ensures that the control rails 31 symmetrically positioned with respect to the force-guided element 50 are always moved synchronously and parallel to direction R1. Therefore, the entire sliding frame 30 by necessity must move precisely in direction R1. Jamming of the pusher 30 with respect to the lifting plate 20 and/or the guide rails 91 is thus prevented. The actuating device 10 ensures consistently precise and uniform guiding of the frame 30 in the guide unit 90.

To ensure that the lifting plates 20, 120 perform a defined and consistently reproducible lifting motion, the motion of the push element 82 in the first direction R1 is limited by stops. The clamping plate 12 forms a first stop, whereas the stop 60 facing the drive 80 forms a second stop. The distance between the end face wall 15 and the stop 60 specifies the actuating distance for the push element 82, and thus for the control rails 31, 131, which consequently may be moved back and forth between at least two defined positions. The lifting plates 20, 120, regardless of the inclination of the grooves 40, 140 and the sliding elements, perform a correspondingly defined lifting motion, whereby targeted intermediate positions may also be attained via the drive 80 when, for example, the shut-off needles 16, 116 are to be brought into various closed and open positions.

The detachable plug-in connections between components 31, 82 and 82, 88 and 31, 131 have the advantage that the actuating device 10 may be quickly and easily installed from above in the recess 13 in the stop plate 12. Only the stops 60, 62 are already inserted in the depression 13. The entire actuating device 10 is thus composed of very few parts which have a simple geometry. The actuating device is very easy to install and may be expanded at any time. Conversely, the lifting elements 20, 120, the control rails 31, 131, the push element 82, and the guide rails 91 may be quickly and easily removed from the clamping plate 12 at any time, for example to exchange defective components, to replace the shut-off needles 16, 116, or to perform other maintenance activities.

The shut-off needles 16, 116 are inserted into the lifting plates 20, 120 from above, the lifting plates being provided with boreholes (not further described). In the region of the lifting plates 20, 120 each needle 16, 116 has threading on the end which is screwed into an essentially rectangular retaining plate (not visible). An adjusting nut (likewise not further described) fixes the needle 16, 116 in place with respect to the retaining plate, which lies flat on the lifting plate 20, 120. In this manner the needles 16, 116 may be individually adjusted in length relative to the lifting plate 20, 120, along the second direction R2.

Each retaining plate rests in a cutout (likewise not shown) whose height essentially corresponds exactly to the height of the retaining plate, and whose outer dimensions are larger than those of the retaining plate, so that the retaining plate may be moved radially inside the cutout. A cover plate 25 fastened to the lifting plate 20 by screws 26 secures the retaining plate in the cutout. The retaining plate is thus fixed in the axial direction of the shut-off needles 16, 116 with the least possible amount of play between the lifting plate 20, 120 and the cover plate 25, so that all needles 16, 116 may be consistently brought into the closed position and reopened in a precise manner. On the other hand, in the radial direction the retaining plates are supported in a floating manner, thereby compensating for deflections of the needles 16, 116 inside the hot runner nozzles. The shape of the retaining plate also rotationally fixes the needles 16, 116 relative to the lifting plate 20.

The adjusting nuts 18 of the needles 16, 116 project through the cover plates 25. To prevent the ends of the needles from projecting too far beyond the lifting plates 20, 120, the retaining plates and the cover plates 25 rest in depressions 24 introduced into the lifting plates 20, 120 from above. The profile height of the actuating device 10 thus remains small.

The lifting plates 20, 120 form a central recess 70 in the middle (see FIG. 1) which continues with the same inner diameter into the clamping plate 12. The recess 70 implements a flow channel of a distribution arm or the like, in particular a machine nozzle or sprue bush (not illustrated), which provides the distribution plate situated below the clamping plate 12 with the plastic composition to be processed. The inner diameter (not further described) of the recess 70 is dimensioned such that the lifting plates 20, 120 are able to move unhindered. The single lifting plate 20 has a centrally located recess 70 (see FIG. 3) which continues with the same inner diameter into the clamping plate 12. This recess 70 as well implements a flow channel of a distribution arm or the like, in particular a machine nozzle or sprue bush (not illustrated).

The end of the actuating device 10 forms a cover plate (not illustrated) which lies flat on the guide rails 91 and is secured thereto by screws (likewise not shown). The cover plate 19 secures all plug-in connections and preferably is in flush abutment with the top side of the clamping plate 12, thus preventing the actuating device 10 from projecting beyond the clamping plate 12. Instead, the device 10 is essentially completely integrated into the clamping plate 12, which is very favorable for the profile height of the mold. Only the drive 80 is externally located on the clamping plate 12, but this has no effect on the profile height thereof.

In the embodiments of FIGS. 1 and 2 a total of thirty-two shut-off needles 16 are fastened to the lifting elements 20, 120. However, the number of shut-off needles 16 may be easily increased or decreased by providing the lifting plates 20, 120 with an appropriate design. For optimal utilization of the mold area provided, multiple mold inserts and therefore multiple needle valve nozzles may be situated very close to one another.

Two actuating devices 10 may also be positioned side by side. For this purpose, the clamping plate 12 is provided with two adjacent depressions 13 or a common depression, so that the control rails 31, 131 and the guide rails 91 for the individual actuating devices 10 are parallel and adjacent to one another.

The invention is not limited to any one of the embodiments described above, and may be modified in various ways. Thus, alternatively or additionally the guide element 52 for the force-guided element 50 may be attached directly to a control rail 31. This may involve the use of a rectangular bolt if needed. The bearing 54 may be designed as a self-lubricating bush which accommodates the bolt 52 with an exact fit and the least possible amount of play.

The control rails 31 and the push element 82 as well as the control rails 31, 131 may also be joined together in a force-fit manner, for example by means of locking elements (not shown). In addition, the lifting elements 20, 120 may be detachably connected to one another. The retaining plates for the shut-off needles 16, 116 may be designed as disks which are flattened at two opposite sides.

The ends (not further described) of the additional control rails 131 facing away from the drive 80 may likewise have a hook-shaped design to allow further control rails to be connected. These hook ends also have a shape that is congruent with the hook ends 33, 34, 133, and have a design resulting in a connection with consistently high tensile strength which may be detached in the direction perpendicular thereto.

The entire actuating device 10 may thus be designed as a modular system which may be individually and flexibly assembled using a small number of base elements 20, 30, 50, 120, 90. All components may be quickly joined together by simple latching or insertion, and may be disconnected as needed. The control rails 31 are provided on both sides with hook-shaped ends, which simplifies manufacture. The actuating device 10 may thus be expanded at any time without great effort, or adapted to a different requirement.

All features and advantages resulting from the claims, description, and drawings, including design details, spatial configurations, and method steps, may be essential to the invention, as such or in various combinations.

### LIST OF REFERENCE NUMERALS

| R1 | First direction |
|---|---|
| R2 | Second direction |
| 10 | Actuating device |
| 12 | Clamping plate |
| 13 | Depression/recess |
| 14 | Base |
| 15 | End face |
| 16 | Shut-off needle |
| 17 | Opening |
| 20 | Lifting element/lifting plate |
| 21 | Sliding element |
| 22 | Lateral surface |
| 23 | Recesses |
| 24 | Depression |
| 25 | Cover plate |
| 26 | Screw |
| 30 | Actuating element |
| 31 | Control rail |
| 33 | Hook-shaped end |
| 34 | Hook-shaped end |
| 40 | Groove |
| 46 | Screws |
| 47 | Screws |
| 50 | Force-guided element |
| 52 | Guide element |
| 54 | Bearing |
| 56 | Guide rail |
| 57 | Screw |
| 60 | Stop |
| 62 | Stop |
| 63 | Screw |
| 66 | Alignment pin |
| 70 | Recess |
| 80 | Drive |
| 82 | Push element |
| 83 | Step-shaped end |
| 84 | End face |
| 86 | Adapter piece |
| 87 | Spring dowel pin |
| 88 | Sliding block |
| 89 | Cutout |
| 90 | Guide unit |
| 91 | Guide rail |
| 92 | Screw |
| 96 | Alignment pin |
| 116 | Shut-off needle |
| 120 | Lifting element/lifting plate |
| 131 | Control rail |
| 133 | Hook-shaped end |
| 140 | Groove |

1. Actuating device (10) for shut-off needles in injection molds having needle valve nozzles, comprising at least one lifting element (20), to which at least one shut-off needle (16) may be fixed, and at least one actuating element (30) which is mounted so that it is longitudinally displaceable in a first direction (R1) and which is coupled to the lifting element (20) in such a way that a motion of the actuating element (30) along the first direction (R1) is converted to a motion of the lifting element (20) in a second direction (R2) transverse to the first direction (R1), characterized in that the actuating element (30), which is slid in a guide unit (90) along the first direction (R1), is provided with an additional force-guided element (50).

2. Actuating device according to claim 1, characterized in that the force-guided element (50) is provided parallel to the guide unit (90).

3. Actuating device according to claim 1, characterized in that the force-guided element (50) is a linear guide.

4. Actuating device according to claim 1, characterized in that the force-guided element (50) has at least one guide element (52) which is slid in a bearing (54).

5. Actuating device according to claim 4, characterized in that the guide element (52) is a round bolt, rectangular bolt, or the like.

6. Actuating device according to claim 4, characterized in that the bearing (54) is a recirculating ball bushing, a self-lubricating bushing, or the like.

7. Actuating device according to claim 1, characterized in that the force-guided element (50) is a flat guide.

8. Actuating device according to claim 7, characterized in that the guide element (52) is a flat element, block piece, sliding block, or the like.

9. Actuating device according to claim 7, characterized in that the bearing (54) is formed by two guide rails (56).

10. Actuating device according to claim 7, characterized in that the bearing (54) is a ball bearing, needle bearing, or roller bearing.

11. Actuating device according to claim 4, characterized in that the guide element (52) and/or the bearing (54) have a self-lubricating design.

12. Actuating device according to claim 4, characterized in that the guide element (52) is connected or fastened to the actuating element (30).

13. Actuating device according to claim 12, characterized in that the actuating element (30) has two sliding control rails (31), and at least two sliding elements are provided in grooves (40) extending obliquely with respect to the first direction (R1) and the second direction (R2), between the lifting element (20) and the control rails (31), the sliding elements converting a motion of the control rails (31) along the first direction (R1) to a motion of the lifting element (20) in the second direction (R2).

14. Actuating device according to claim 12, characterized in that the actuating element (30) is connected to a drive (80) via a push element (82).

15. Actuating device according to claim 14, characterized in that at least one guide element (52) is fastened to the push element (82).

16. Actuating device according to claim 14, characterized in that the guide element (52) is designed as one piece with the push element (82).

17. Actuating device according to claim 4, characterized in that at least two force-guided elements (50) and/or two guide elements (52) are provided adjacent and parallel to one another.

18. Injection mold having at least one actuating device (10) according to claim 1.

19. Injection mold according to claim 18, characterized in that the actuating device (10) is provided in or on a clamping plate (12).

20. Injection mold according to claim 18, characterized in that the bearing (54) for the force-guided element (50) is provided on or in the clamping plate (12).

21. Injection mold according to claim 18, characterized in that the guide unit (90) is provided on or in the clamping plate (12).

22. Injection mold according to claim 21, characterized in that the guide unit (90) for the actuating device (10) is formed by the clamping plate (12).

23. Injection mold according to claim 21, characterized in that the guide unit (90) for the actuating device (10) has at least two guide rails (91) which are fastened on or in the clamping plate (12), and the control rails (31, 131) are slid between the guide rails (91).

24. Injection mold according to claim 21, characterized in that the actuating element (30) and/or the guide unit (90) and/or the clamping plate (12) have or bear sliding elements (35, 93).

25. Injection mold according to claim 24, characterized in that the sliding elements (35, 93) are sliding strips or sliding plates.

26. Injection mold according to claim 24, characterized in that the sliding elements (35, 93) are made, at least partially, of a self-lubricating material or are at least partially coated with same.

27. Injection mold according to claim 26, characterized in that the sliding elements (35, 93) are, or form, ball bearings, needle bearings, or roller bearings.
